(19) United States
(12) Patent Application Publication
(10) Pub. No.: US 2004/0133550 A1
(43) Pub. Date: Jul. 8, 2004

(54) File transfer program

(75) Inventor: Koki Okamura, Asaka-shi (JP)

Correspondence Address: MCGINN & GIBB, PLLC, 8321 OLD COURTHOUSE ROAD, SUITE 200, VIENNA, VA, 22182-3817, US

(73) Assignee: Fuji Photo Film Co., Ltd., Minami-Ashigara-shi (JP)

(21) Appl. No.: 10/733,380

(22) Filed: Dec. 12, 2003

(30) Foreign Application Priority Data
Dec. 13, 2002 (JP) 2002-361998

(51) Int. Cl. G06F 7/00

(52) U.S. Cl. 707/1

(57) ABSTRACT

The file transfer program makes a computer achieve: a function, when a file stored in a first folder is selected to be stored into a second folder, to compare a filename of the selected file with a filename of each file already stored in the second folder; a function, if the second folder contains no file having a filename same as the selected file, to store the selected file into the second folder; and a function, if the second folder contains a file having a filename same as the selected file, to display thumbnail images and file information of the selected file and the file having the same filename together on a display device. Thus, the user can easily decide at a glance whether or not the file should be overwritten, and operability of file transfer is improved.

### BACKGROUND OF THE INVENTION

1. Field of the Invention

The present invention relates to a file transfer program, and more particularly to a file transfer program that improves operability of file transfer in processing of multimedia files with a personal computer.

2. Description of the Related Art

In processing of multimedia files with a personal computer, when a file stored in a folder is selected to be stored into another folder, it is generally performed to attach a filename to the selected file and to store it into the other folder.

By the spread of digital cameras, users can easily create digital image data. Generally, image data captured with a digital camera are copied to a mass storage device, such as a hard disk of a personal computer, to be accumulated and stored. Also in this case, operations to transfer image data files are necessary. For this type of technology, various proposals are disclosed (refer to Japanese Patent Application Publication No. 11-234615, for example).

In the above-described conventional file transfer method, problems to be explained below may easily occur in overwrite of a file or other processings. When a file stored in a first folder is selected to be saved in a second folder, it is generally performed to create a copy of the selected file, name the copy the same filename after the selected file, and store the copy into the second folder. At this time, if the second folder already contains another file that has the same filename as the selected file, the user must decide whether the two files should exist independently in the second folder, overwrite of the selected file onto the file in the second folder should be performed, or save processing should be halted.

If contents of the file that has the same filename and already exists in the second folder are different from those of the file to be newly saved, a filename of the file to be newly saved should be made different from the filename of the file that already exists in the second folder. On the other hand, if the file that has the same filename and already exists in the second folder is an old version of the file to be newly saved, the new file should overwrite the old file in the second folder. However, contents of individual file cannot generally be understood at a glance in a display screen of file transfer.

To solve such a problem, Japanese Patent Application Publication No. 11-234615 proposes a system in which the identity of a file is determined according to a code peculiar to the file in file transfer, so as to decide transfer or skip. However, a file with a peculiar code is one that is specially formatted, and ordinary files are not attached with peculiar codes, so that the use of this system is limited.

### SUMMARY OF THE INVENTION

The object of the present invention is to provide a file transfer program that allows users to easily decide at a glance whether or not a file should overwrite and improves operability of file transfer in processing of multimedia files with personal computers or other devices.

In order to attain the above-described object, the present invention is directed to a file transfer program which makes a computer achieve: a function, when a file stored in a first folder is selected to be stored into a second folder, to compare a filename of the selected file with a filename of each file already stored in the second folder; a function, if the second folder contains no file having a filename same as the selected file, to store the selected file into the second folder; and a function, if the second folder contains a file having a filename same as the selected file, to display thumbnail images and file information of the selected file and the file having the same filename together on a display device.

According to the present invention, if there is a file, in the target folder, having the same filename as a file selected to be transferred into the target folder, thumbnail images and file information of the selected file and the file having the same filename are displayed together on a display device. Subsequently, decision whether or not to overwrite the file is promoted.

For example, in the case of a still image file, the still image in the folder is reduced and then displayed as its thumbnail image. Therefore, by comparing both of the thumbnail images, decision whether or not to overwrite the file can be executed at a glance and operability of file transfer is improved.

In the above description, a filename attached to a file means a filename with extension, e.g., “DSCF0001.JPG”.

Preferably, the file transfer program makes the computer further achieve: a function, if at least one of the selected file and the file having the same filename is a movie file, to display a first frame of the movie as the thumbnail image thereof on the display device, and to play back the movie upon operation to the thumbnail image.

In displaying thumbnail images and file information of two or more files together, if the first frame of a movie is displayed, contents of the file can be determined at a glance and operability of file transfer is improved. Furthermore, by operating a thumbnail image (e.g., click operation), a movie is played back, so that contents of the file become clearer and operability of file transfer is improved.

Preferably, the file transfer program makes the computer further achieve: a function, if at least one of the selected file and the file having the same filename is an audio file, to display an icon image as the thumbnail image thereof on the display device, the icon image indicating that the file is audio, and to play back the audio upon operation to the icon image.

The present invention is also directed to a file transfer program which makes a computer achieve: a function, when an audio file stored in a first folder is selected to be stored into a second folder, to attach a filename to the selected file and store the selected file into the second folder; a function to display an icon image on a display device, the icon image indicating that the file is audio, for the selected file and an audio file stored in the second folder; and a function to play back the audio upon operation to the icon image.

According to the present invention, even for audio files, the contents of which cannot easily be determined visually, icon images that indicate they are audio files are displayed. By operating the icon images (e.g., click operation), audio is played back. Thereby, decision whether or not to overwrite a file can easily be executed, and operability of file transfer is improved.

### BRIEF DESCRIPTION OF THE DRAWINGS

The nature of the present invention, as well as other objects and advantages thereof, will be explained in the following with reference to the accompanying drawings, in which like reference characters designate the same or similar parts throughout the figures and wherein:

FIG. 1 is a block diagram showing an example of hardware structure of a personal computer having a file transfer program according to an embodiment of the present invention;

FIG. 2 is a flowchart of the file transfer program according to the embodiment;

FIG. 3 shows a screen on a monitor device in which an image list of image files is displayed;

FIG. 4 shows a screen on the monitor device in which a window screen to designate a target folder is displayed;

FIG. 5 shows a screen on the monitor device in which thumbnail images of a file in the source of transfer and a file in the target folder that have the same filename are displayed; and

FIG. 6 shows an example of icon image indicating an audio file.

### DETAILED DESCRIPTION OF THE PREFERRED EMBODIMENTS

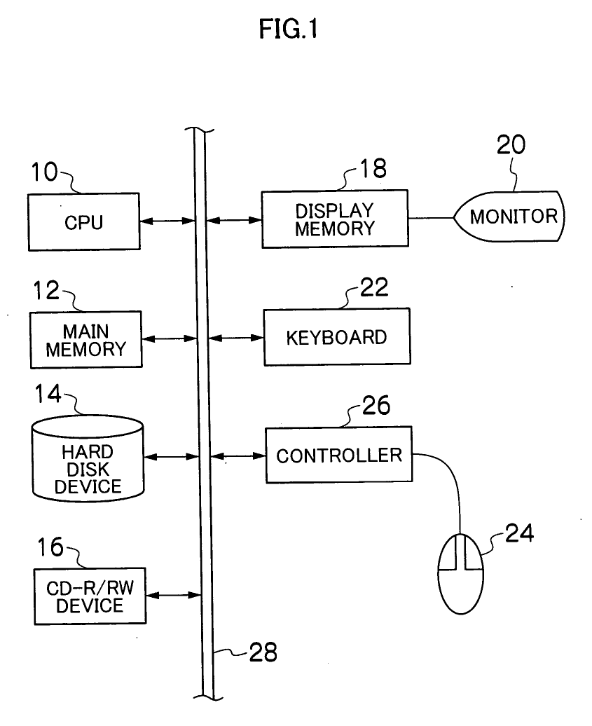

Hereafter, preferred embodiments of a file transfer program according to the present invention will be explained in details with reference to the attached drawings. FIG. 1 is a block diagram showing an example of hardware structure of a personal computer having a file transfer program according to an embodiment of the present invention.

As shown in FIG. 1, the personal computer comprises: a central processing unit (CPU) 10, which mainly controls operations of each structure element; a main memory 12, which is used for storage of control programs of the apparatus and becomes a work area when the programs are executed; a hard disk device 14, in which an operating system (OS) of the personal computer, the file transfer program according to the embodiment of the present invention, various kinds of application software, user's images, and other data are stored; a CD-R/RW device 16, which can read from CD-ROM or, read from and write to CD-R; a display memory 18, which temporarily stores display data; a monitor device 20, such as a CRT monitor or an LCD monitor, which displays images and/or characters according to image and/or character data stored in the display memory 18; a keyboard 22; a mouse 24 as a position input device; a mouse controller 26, which detects states of the mouse 24 and outputs signals of a position of the mouse pointer on the monitor device 20 and/or states of the mouse 24 to the CPU 10; and a bus 28, which connects the above-described structure elements with each other.

The personal computer, which has the above-described structure, has already been known except for the file transfer program stored in the hard disk device 14, so that detail description of each structure element is omitted.

Next, an outline of the file transfer program according to the embodiment of the present invention will be explained. When a user designates a folder, in which image files and any other data are stored, on the hard disk device 14, the file transfer program restructures data stored in all layers in the folder into a format, such as a CD album format that is suitable for recording into CD-R, and writes the data onto other areas in the hard disk device 14 and/or a CD-R. Hereinafter, an example will be explained, in which N files stored in a recording medium of a digital camera are transferred to the hard disk device 14 of the personal computer.

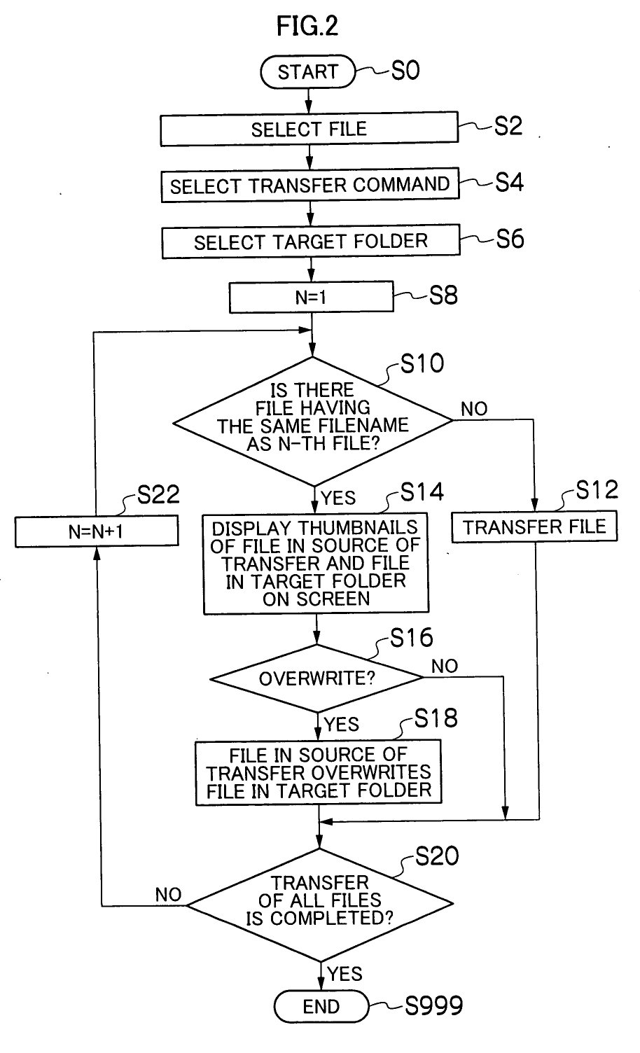

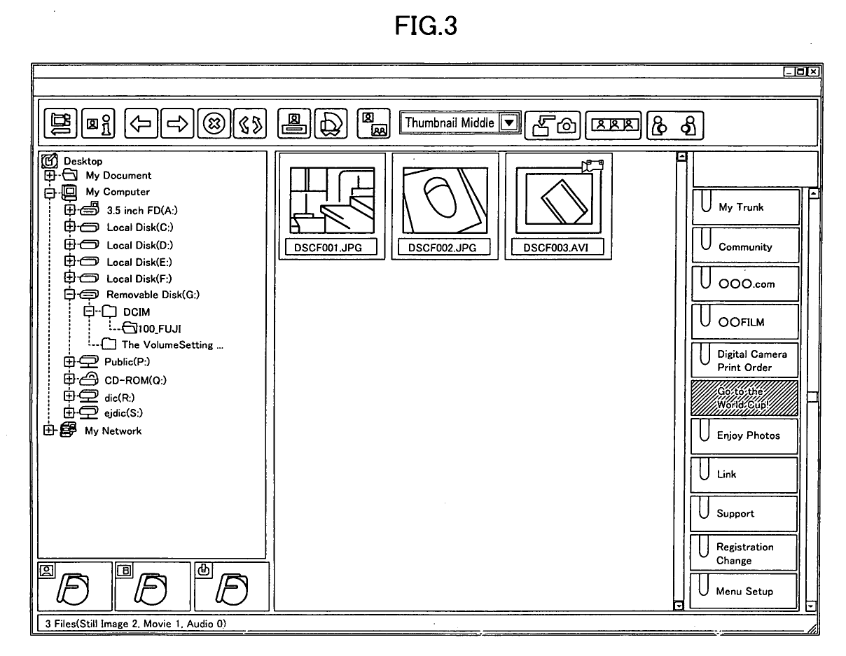

An outline flow of the file transfer program according to the embodiment of the present invention will be explained in accordance with a flow chart shown in FIG. 2. When the personal computer is started and a viewer software is activated, a folder in the hard disk device 14 is designated (in this example, 100_FUJI), and an image list of image files stored in the folder is displayed on the monitor device 20 as shown in FIG. 3, in which two still image files of DSCF0001.JPG and DSCF0002.JPG, and one movie file of DSCF0003.AVI are displayed as thumbnail images (step S0 in the state “start”).

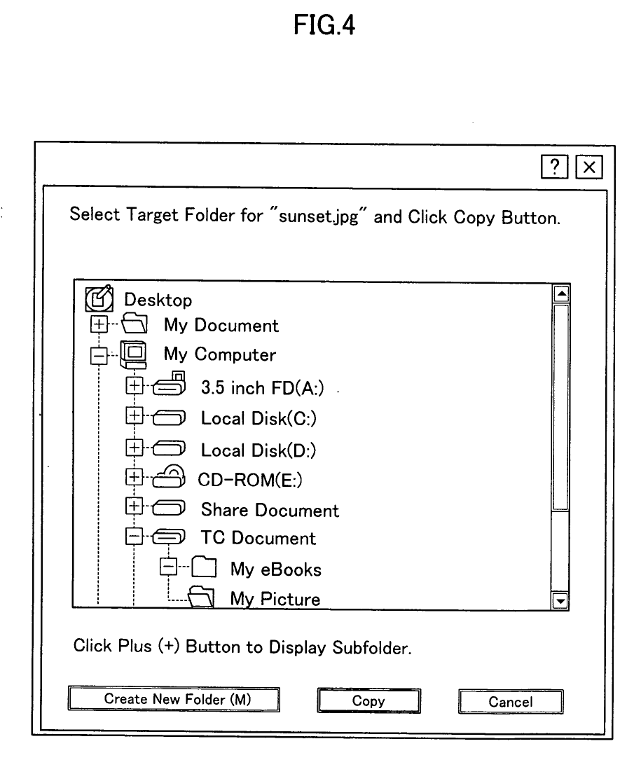

Next, a file to be transferred is selected on the screen shown in FIG. 3 (step S2). Usually, this operation is performed with the mouse 24, and a pointer is placed on the thumbnail image of the file to be selected and then the mouse 24 is right-clicked. In usual viewer software, a popup menu screen (not shown) is then displayed. In the popup menu screen, a transfer command is selected and then clicked (step S4). Thereby, a window screen to designate a target folder is displayed on the monitor device 20 as shown in FIG. 4, and selection of the target folder is prompted (step S6). According to this, the target folder is selected. Usually, this operation is performed with the mouse 24, and a file to be selected is designated by a pointer and then “copy” button is clicked.

After that, a counter in the program is set so that N=1 (step S8), and then it is determined whether or not the target folder contains a file having a filename that is the same as the filename of the Nth (in this state, N is 1) file to be transferred (step S10). If the target folder contains no file having the same filename as the Nth file, the Nth file is stored into the target folder (step S12) and then the processing proceeds to step S20.

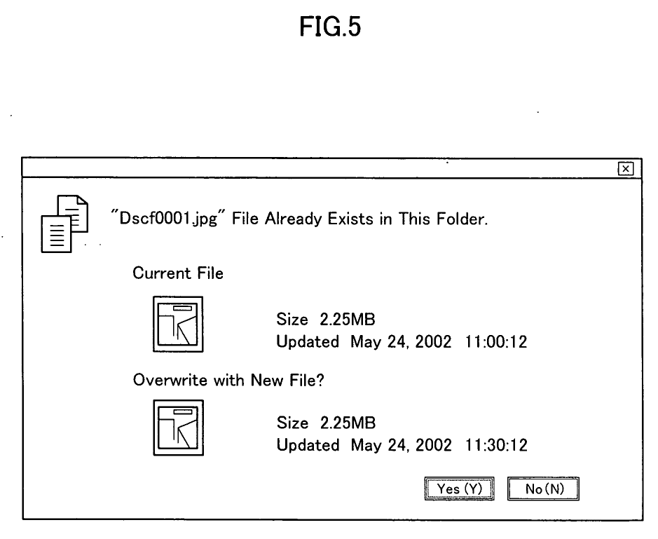

On the other hand, if the target folder contains a file having the same filename as the Nth file at step S10, thumbnail images of the file in the source of transfer and the file in the target folder that have the same filename, are displayed together on the monitor device 20 (step S14) as shown in FIG. 5, and a message is displayed to show that the target folder contains the file having the same filename as the Nth file and to ask whether or not overwrite should be performed. Moreover, file information is also displayed on the side of each thumbnail image.

In FIG. 5, the example is shown in which both of the file in the source of transfer and the file in the target folder that have the same filename are still image files. In the case where at least one of the files having the same filename is a movie file, the first frame of the movie is displayed as its thumbnail image. With such a structure, contents of the file can be determined at a glance. Moreover, the movie can be played back upon operation (e.g., click operation) to the thumbnail image, so that contents of the file become clearer.

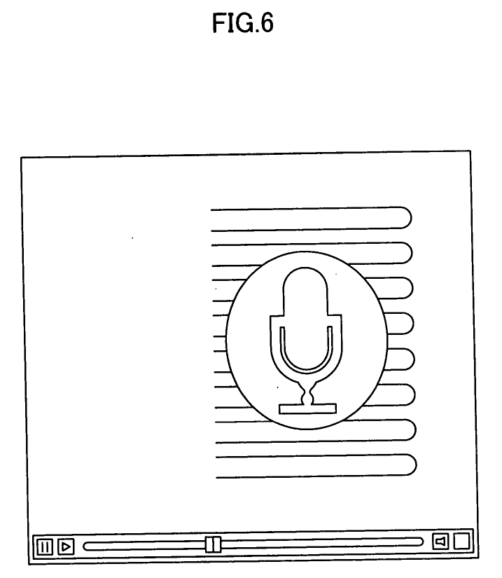

On the other hand, in the case where at least one of the files having the same filename is an audio file, an icon image shown in FIG. 6, which indicates that the file is audio, is displayed on the monitor device 20. With such a structure, even for an audio file that it is hard to visually determine contents of the file, it becomes clear that the file is an audio file. Moreover, the audio can be played back upon operation (e.g., click operation) to the icon image, so that contents of the file become clearer. The icon image shown in FIG. 6 shows the outline of a microphone; however, any form other than this can also be adopted.

Then, decision whether or not to overwrite the file, based on the acquired information at step S14, is prompted (step S16). If overwrite of file is not necessary, the processing proceeds to step S20. On the other hand, if overwrite of file is necessary, the file in the source of transfer overwrites the file having the same filename in the target folder (step S18).

At the next step S20, the flows from steps S12, S16 and S18 are joined. At this step S20, whether or not transfer of all N files to be transferred is completed is determined. If completed, the program ends (step S999). On the other hand, if not completed, the counter in the program is incremented, that is N=N+1 (step S22), and the processing is returned to step S10. Subsequently, the same loop is repeated, and after all N files to be transferred are transferred at step S20, the program ends (step S999).

In the above, embodiments of the file transfer program according to the present invention are explained; however, the present invention is not restricted to the above-described embodiments and various embodiments can be adopted.

In the above embodiments, a personal computer is adopted as an example of hardware structure. Alternatively, a digital camera is similarly applicable as a hardware structure.

Display screens and thumbnail images in the above embodiments are examples, and various forms can be adopted.

As described above, according to the present invention, if there is a file, in the target folder, having the same filename as a file selected to be transferred into the target folder, thumbnail images and file information of the selected file and the file having the same filename are displayed together on a display device. Subsequently, decision whether or not to overwrite the file is promoted.

In the case of a still image file, the still image in a folder is reduced and displayed as its thumbnail image. Thereby, by comparing both thumbnail images, decision whether or not to overwrite the file is performed at a glance, and operability of file transfer is improved.

Even in the case of an audio file, the contents of which cannot visually determined, an icon image that indicates an audio file is displayed. By operating the icon image (e.g., click operation), audio is played back. Thereby, decision whether or not to overwrite the file is easily performed, and operability of file transfer is improved.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A file transfer program which makes a computer achieve:
a function, when a file stored in a first folder is selected to be stored into a second folder, to compare a filename of the selected file with a filename of each file already stored in the second folder;
a function, if the second folder contains no file having a filename same as the selected file, to store the selected file into the second folder; and
a function, if the second folder contains a file having a filename same as the selected file, to display thumbnail images and file information of the selected file and the file having the same filename together on a display device.

2. The file transfer program as defined in claim 1, which makes the computer further achieve:
a function, if at least one of the selected file and the file having the same filename is a movie file, to display a first frame of the movie as the thumbnail image thereof on the display device, and to play back the movie upon operation to the thumbnail image.

3. The file transfer program as defined in claim 1, which makes the computer further achieve:
a function, if at least one of the selected file and the file having the same filename is an audio file, to display an icon image as the thumbnail image thereof on the display device, the icon image indicating that the file is audio, and to play back the audio upon operation to the icon image.

4. A file transfer program which makes a computer achieve:
a function, when an audio file stored in a first folder is selected to be stored into a second folder, to attach a filename to the selected file and store the selected file into the second folder;
a function to display an icon image on a display device, the icon image indicating that the file is audio, for the selected file and an audio file stored in the second folder; and
a function to play back the audio upon operation to the icon image.
